(19) United States
(12) Patent Application Publication
(10) Pub. No.: US 2016/0141908 A1
(43) Pub. Date: May 19, 2016

(54) METHOD AND APPARATUS FOR EFFICIENCY COMPLIANCE IN WIRELESS CHARGING SYSTEMS

(71) Applicant: MOTOROLA SOLUTIONS, INC, SCHAUMBURG, IL (US)

(72) Inventors: DANIEL J. JAKL, (US); JOHN E. HERRMANN, (US)

(21) Appl. No.: 14/541,190

(22) Filed: Nov. 14, 2014

(51) Int. Cl. H02J 7/02

(52) U.S. Cl. CPC H02J 7/025

(57) ABSTRACT

A method and system for efficiency compliance in a wireless battery charging system includes a wireless power source that provides a wireless charging power signal to devices in proximity to the wireless power source. The devices have a receiving coil to receive electrical energy from the wireless charging power signal, and they communicate battery charging metrics to the wireless power source. The wireless power source uses the battery charging metrics to determine a predicted system efficiency to charge the devices over a period of time, and when the predicted efficiency is below an efficiency standard, the wireless power source undertakes an action to improve system efficiency.

### FIELD OF THE DISCLOSURE

The present disclosure relates generally to wireless battery charging, and more particularly to methods and devices for wireless charging in compliance with efficiency regulations.

### BACKGROUND

Wireless charging refers to the use of energy transfer by electromagnetic coupling from a charging source to an appropriately configured battery pack or device including a battery pack where the energy received by the battery pack is used to recharge one or more electrochemical cells contained in the battery pack. This type of charging is sometimes referred to as “loosely coupled” because, unlike earlier inductive charging arrangements, the battery pack being charged can be placed within an area, rather than in a specific position, such as mounted on an inductive spindle or rod. In wireless charging systems, a device having a battery and wireless charging circuitry can be placed in proximity to the wireless charging source with much less regard for particular orientation or position compared to inductive charging systems. In addition to the freedom it affords a user in placing a battery in proximity to the charger, it further allows multiple such batteries to be placed in proximity to the charger to be charged at the same time.

While wireless charging allows users the ability to easily recharge multiple devices with one charging unit, such charging units have certain inherent losses due to the inefficiency of the wireless coupling. Some jurisdictions have adopted regulations regarding appliance efficiency (and others are looking into such regulations) which affect the amount of energy allowed by the charging system based on, in-part, the amount of energy recovered from the charged battery(s).

Accordingly, there is a need for a method and apparatus for ensuring wireless charging systems will meet mandated energy efficiencies.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of a wireless charging system that complies with efficiency requirements, in accordance with some embodiments;

FIG. 2 is a block diagram of a wireless charging system that is controlled remotely, in accordance with some embodiments;

FIG. 3 is a block diagram showing communication of information between a device that has a battery being wirelessly charged and a wireless charger, in accordance with some embodiments;

FIG. 4 is a block diagram of a wireless charging system using a repeater to meet a charging efficiency requirement, in accordance with some embodiments; and

FIG. 5 is a flowchart of a method used by a wireless charger to meet a charging efficiency requirement, in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Embodiments in accordance with the following disclosure include a method for operating a wireless charging system. The method includes detecting a device containing a battery in charging proximity to a wireless power source, where the device contains battery charging metrics, either in the device itself or in a battery back attached to the device. The method can further include providing, by the wireless power source, a wireless charging power signal. The wireless charging power signal can transfer energy to a receiving device. The method can also include communicating the battery charging metrics to the wireless power source, which can commence predicting a charging efficiency for charging the battery according to a charging efficiency standard. When the predicted charging efficiency is below a preselected threshold, the wireless charger commence an action to increase the predicted charging efficiency.

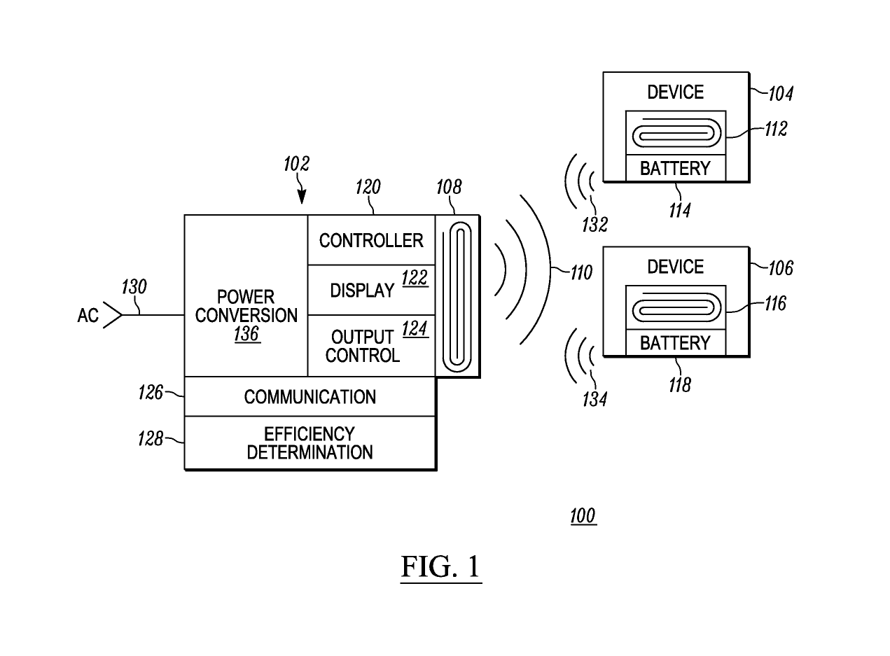

FIG. 1 is a block diagram of a wireless charging system 100 that complies with efficiency requirements, in accordance with some embodiments. The efficiency requirements can be government-mandated requirements as specified by a published standard. A wireless power source or charger 102 provides a wireless charging power signal 110 that can be received at devices such as device 104 and device 106. The wireless charging power signal 110 is an alternating current (AC) electromagnetic signal used to transfer energy from the wireless charger 102 to the devices 104, 106 for charging a battery used by the devices 104, 106. The wireless charger 102 drives a charger coil 108 with an AC power circuit in the wireless charger 102 with an AC wave to produce the wireless charging power signal 110. Each device 104, 106 contains a receiving coil 112, 116, respectively, which can receive the wireless charging power signal 110 and some of the energy in the wireless charging power signal 110. The energy is received by the receiving coils 112, 116 produces an electrical current and voltage that can be used to charge a battery 114, 118, respectively, for each device 104, 106. Some of the energy can also be used to power the devices 104, 106.

The wireless charging power signal can be loosely coupled between the wireless charger 102 and the devices 104, 106 because the devices 104, 106 can be freely positioned with respect to the wireless charger within a charging area. In some embodiments, for example, the charger coil 108 can be positioned under a surface on which the devices 104, 106 can be placed. Additional devices similar to devices 104,106 can also be placed in proximity to the charger coil 108 in order to charge batteries in such additional devices as well. The effectiveness of energy transfer from the charger coil 108 to the devices 104, 106 is dependent on the placement of the devices 104, 106 relative to the charger coil 108, as well the design of the charger coil 108 and the receiving coils 112, 116. The charger coil 108 and the receiving coils 112, 116 are designed to be substantially resonant at the frequency of the wireless charging power signal 110. In general, the wireless charging power signal 110 is a relatively low voltage, high current signal in the radio frequency range that maintains most of its energy in a near magnetic field, rather than radiating the energy in an electric field away from the charger coil 108.

The wireless charger 102 includes a controller 120 which operates and supervises various functions of the wireless charger 102. In some embodiments the wireless charger 102 can include a graphical display 122 for outputting information graphically so that a user can see the information. The output of the charging coil 108 can be controlled by an output control circuit 124 that can include, for example, frequency generation and power amplification functions to drive the charging coil 108 to create the wireless charging power signal 110. The power for the output control circuit 124, and other functions of the wireless charger 102 can be derived from an AC input source 130, which can be a standard commercial AC service (e.g. 110/220 VAC). A power conversion circuit 136 converts the input AC to direct current (DC) voltage and measures the input power as an input power metric which can be provided to the controller 120 for determining system efficiency.

In order to determine system efficiency, the wireless charger 102 can include a communication circuit 126 that allows the wireless charger 102 to communicate with the devices 104, 106, which are likewise equipped with compatible communication circuitry. In some embodiments the communication between the wireless charger 102 and the devices 104, 106 can be wireless communication performed according to a known short range radio communication protocol, such as, for example, that specified by subsections of the Institute of Electrical and Electronic Engineers (IEEE) specification no. 802.15, which includes specifications known by the trade name BlueTooth. Each device 104, 106 can communicate charging metrics 132, 134 to the wireless charger 102. Charging metrics can include both static and dynamic information. Static information can include battery capacity, while dynamic information can include the rate at which the battery is being charged, the present state of charge of the battery, and so on. The charging metric information can be used by the wireless charger 102 to determine a present and a predicted charging efficiency.

Charging can commence by the detection of the presence of a device 104, 106 by the wireless charger 102, or by the presence of the wireless charger 102 by a device 104, 106, or by mutual detection. For example, the wireless charger 102, when not actively providing the wireless charging power signal 110, can periodically provide a signal of short duration (i.e. pulse) at the charging coil 108 which can be received by a receiving coil 112, 116 and detected by a device 104, 106. Once the device 104, 106 detects the presence of the wireless charger 102 via the pulse from the charging coil 108, the device 104, 106 can use its communication circuit to transmit a probe message to the wireless charger 102, whereupon the wireless charger can commence providing the wireless charging power signal 110. Once the wireless charging power signal 110 is commenced, at some time thereafter the device 104, 106 can transmit the charging metrics 132, 134, which can be processed by an efficiency determination function 128 of the wireless charger 102 which predicts charging efficiency.

In some embodiments the charging efficiency is predicted in accordance with an applicable standard, or other efficiency criteria. For example, the California Energy Commission has set forth charging efficiency standards in Title 20 of the California Code of Regulations, sections 1601-1608. A charging efficiency prediction can, for example, obtain data from the device regarding the full charge capacity of its battery. The full charge capacity indicates an amount of energy that can be recovered from the battery upon being fully charged as determined, for example, by a charging algorithm. The full charge capacity is used to calculate the energy that the charging system can use for a given period of time, based on the efficiency requirement. The full charge capacity can be divided by the allowed efficiency, for example, to determine the energy that the charging system can use over that time period. The charging system can then determine its power consumption at various charge rates actually experienced by the battery. The actual charge rate experienced by the battery will be dependent upon the amount of power received by the battery via the wireless charging power signal 110, which can depend on the coupling efficiency between the charging coil 108 and the receiving coil 112 or 116. The input power measurement also takes into account power consumption after the battery is fully charged, even if the battery is no longer in charging proximity (i.e. removed). Then the energy required to charge the battery can be calculated or predicted using a known charging profile for the capacity and type (i.e. chemistry) of battery being charged, such as by integrating power over time for a given charging profile. The charging profile specifies voltage and current over time while charging for a given charging rate. The system can then predict whether compliance with the charging efficiency standard will be achieved by comparing the energy required to charge the battery over the given time period with the efficiency limit. When multiple batteries are being charged, the system efficiency in total can be likewise predicted by summing the energy requirements and expected recoverable energy from the totality of batteries being charged. In some embodiments the wireless charger 102 can be designed to allow a user to specify (i.e. input) an efficiency value that the wireless charger uses as the efficiency standard. In some embodiments the efficiency standard can be programmed or specified by the manufacturer or a seller of the wireless charger 102 based on a region where the wireless charger is sold.

Once the efficiency prediction for a device and the system in sum is determined, the wireless charger 102 can compare the predicted efficiency to a goal or other preselected threshold. When the charging efficiency is predicted to fail meeting the preselected threshold, the wireless charger 102 can take one of a variety of actions to remediate the charging conditions and improve the efficiency. For example, the wireless charger 102 can communicate a message to a device 104, 106 indicating that the particular device is not going to meet the desired efficiency. The messaged device can then prompt a user to move the messaged device for better coupling with the wireless charging power signal 110. The user-prompt message can be a visual or graphical prompt, an audible or vibration prompt, or a combination.

Alternatively, the wireless charger can indicate on, for example, a display 122 an identity of a device that is not meeting a desired efficiency, which can allow a user to reposition the identified device for better coupling with the wireless charging power signal 110. In some embodiments the action taken by the wireless charger 102 can be to message a particular device that appears, based on the efficiency prediction determination, that the device is not going to meet the desired efficiency to reduce its internal load so that more of the power received by the receiving coil 112, 116 can be diverted into charging the battery rather than for powering circuitry in the device that may not need to be powered. The wireless charger 102 can undertake a schedule of different actions in an attempt to improve the efficiency.

Each time an action is undertaken the wireless charger 102 can again perform the efficiency determination and again compare the new efficiency determination with the preselected threshold for efficiency. If the new efficiency determination does not meet the preselected threshold for efficiency, then a next action can be undertaken. For example, the wireless charger can first alert a user to move device 104, either by messaging device 104, causing device 104 to issue a prompt, or by issuing a prompt at the wireless charger 102. In some embodiments the device 104 can provide a graphical indication of the strength of the signal received at the receiving coil 112 to facilitate moving the device 104 into an optimum location relative to the wireless charger power signal 110.

If moving the device 104 still does not produce a result that will achieve the desired efficiency, then the wireless charger can message device 104 to reduce its internal load to allow more of the received power to go into charging the battery 114. If, after one or more measures have been tried and the efficiency determination continues to fail to meet the desired preselected threshold, the wireless charger 102 can simply cease providing the wireless charging power signal 110.

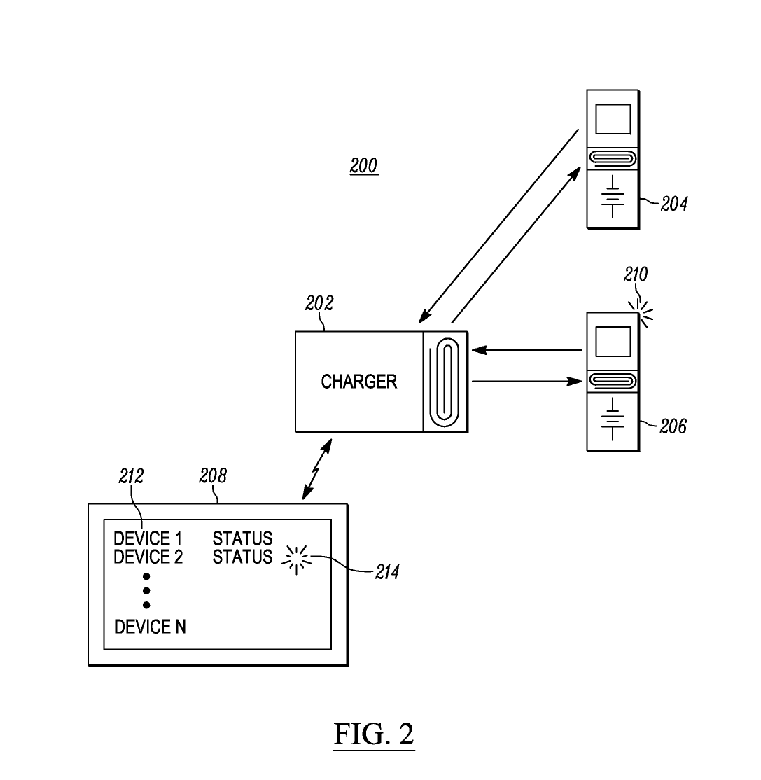

FIG. 2 is a block diagram of a wireless charging system 200 that is controlled remotely, in accordance with some embodiments. A wireless charger 202 provides a wireless charging power signal to charge the battery in each of one or more devices 204, 206. The devices can be, for example, cellular telephones, portable two-way radios, accessory devices, tablet computing devices, or any other device that can use a rechargeable battery. The wireless charging system 200 (and 100) is particularly suited for use by organizations that have a number of personnel who carry communication devices such as portable two-way radios and accessories. The wireless charger can communicate with the devices 204, 206, as well as a remote device 208. The remote device 208 can be a portable computing device (e.g. laptop computer, smartphone, tablet computing device, etc.). A program or application running on the remote device 208 can communicate and control the wireless charger 202.

When a device 204, 206 is being charged by the wireless charger (i.e. by a wireless charging power signal) the devices 204, 206 communicate charging metrics to the wireless charger 202 which relays the information to the remote device 208. Alternatively the devices 204, 206 can communicate information directly to the remote device 208. The program running on the remote device 208 can display information such as an identifier 212 of each device 204, 206, a charging status (i.e. charging rate, state of charge, estimated time to full charge, and so on), and a charging efficiency, as well as a system-wide charging efficiency. Devices that have a low efficiency number (i.e. under a preselected threshold) can be visually flagged 214 on the display of the remote device 208. A user can highlight and select a particular device, such as one showing an unacceptably low efficiency, and cause the remote device 208 to communicate a message to the selected device (directly or through the wireless charger 208) causing the selected device to provide a visual or other indication 210 so that it can be identified and moved. This allows easy identification of a device among a plurality of similar-looking devices that are also being charged. The message sent to the selected device can also or alternatively cause the selected device to reduce its power consumption.

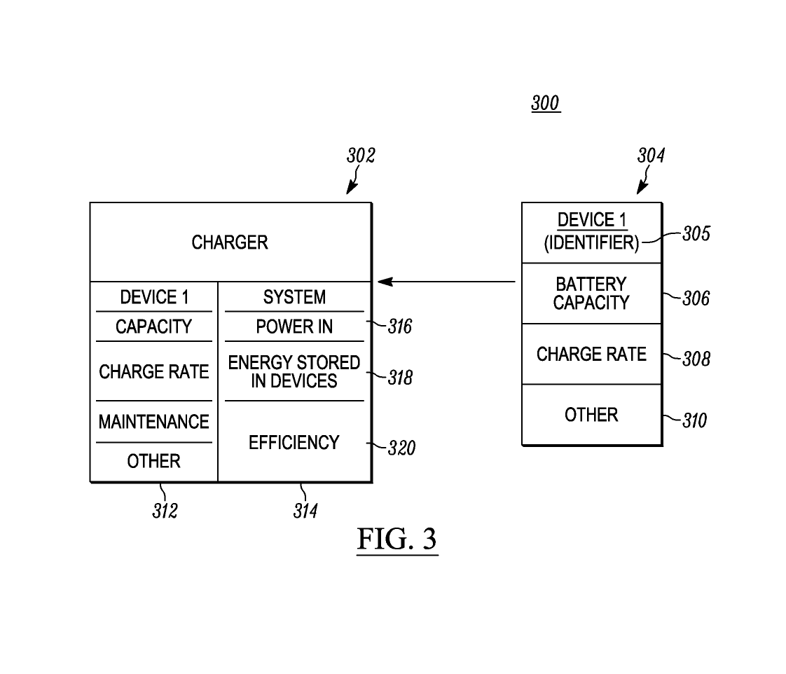

FIG. 3 is a block diagram of a system 300 showing communication of information between a device 304 that has a battery being wirelessly charged and a wireless charger 302, in accordance with some embodiments. A device 304 can include a battery and a receiving coil as substantially shown in FIG. 1, and can maintain battery and charging information. For example, the device can include an identifier 305 that can be uniquely associated with the device battery used by the device, or which can be assigned by the wireless charger 302 upon initially communicating with the wireless charger 302. The identifier 305 is used in communicating data to the wireless charger 302, and by the wireless charger to direct messages to the device 304. The identifier 305 can be, for example, the media access controller (MAC) address of a wireless network transceiver, a serial number, a dynamically assigned network address, and so on. The device 304 obtains both static and dynamic battery data, such as a battery capacity 306, a present charger rate 308 as determined by a charge controller, and other information 310 such as an indication of battery chemistry, a maintenance charge rate, a present state of charge, and battery charge cycle count. Such information can be transmitted to the wireless charger 302 for determination of charging efficiency.

The wireless charger 302 (or a remote device such as remote device 208) can keep a device record 312 of each device which is being charged. The device record 312 can be keyed by device identifier 305 and include information provided by the device 304, including battery capacity, a present charging rate, and a maintenance charge rate, among other information. The present charge rate refers to the rate at which the battery is presently being charged, which will typically be less than the rate of energy being received by the device since the device must provide power to its circuitry. Therefore the device 304 must divert enough power received at its receiving coil to power the device circuitry before charging can commence. Otherwise, if the device's receiving coil receives less power than is necessary to power the device's circuitry, the battery will continue to discharge, but at a slower rate.

The wireless charger 302 also keeps a system record 314 that indicates the power 316 into the wireless charger 302 from the commercial AC source, the energy 318 that will be stored in the battery or batteries of the device or devices being charged by the wireless charger 302, and a presently determined efficiency 320, based on the amount of energy received, and the amount of energy that will be stored in the battery or batteries of devices being charged or maintained by the wireless charger 302 over a given period of time as specified by an applicable regulation or standard, or other criteria. The efficiency 320 can include both a system-wide efficiency (assuming there is more than one device present), as well as individual efficiency determinations for each device being charged or maintained. The individual efficiency determination figures can be used to identify devices having a relative low efficiency, and such identified devices can be the target of remediation measures (i.e. relocating them relative to the wireless charger 302, reducing internal load, commanding the device to shut off, etc.).

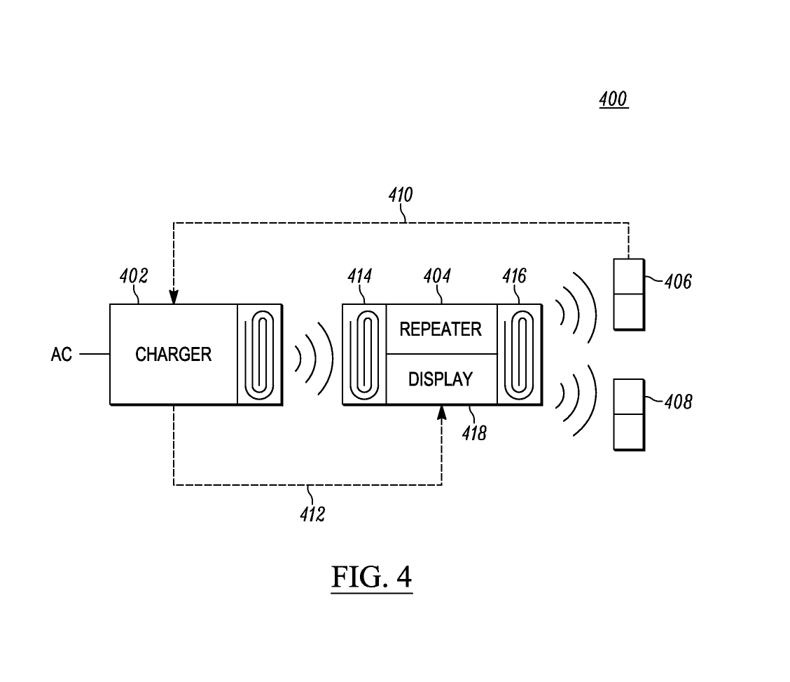

FIG. 4 is a block diagram of a wireless charging system 400 using a repeater to meet a charging efficiency requirement, in accordance with some embodiments. A wireless charger 402 provides a wireless charging power signal that is received by a repeater 404. The repeater 404 can also provide a wireless charging power signal for charging one or more devices 406, 408. In some embodiments the devices can communicate 410 with the charger 402, with the repeater 404, or both. Similarly, the wireless charger 402 can communicate 412 with the repeater 404. The wireless charger 402 is powered by commercial AC service. Power can be received at the repeater 404 by a receiving coil 414 and retransmitted using receiving coil 414 or another coil 416. The repeater 404 can include a display 418 which can be used to display charging and efficiency status for each device as well as the overall system which can allow a user to identify which, if any, device or devices may need to be relocated while being charged to improve efficiency.

Devices in systems 100-400 may periodically need to be repositioned with respect to the wireless charger by which they are being recharged, even after being initially placed. This is because, in an organization there may be several devices placed in charging proximity to a given wireless charger. As more devices are added, some will have to be located at positions of less than optimal charging. While, in general, the more devices there are being charged, the better the system efficiency will be, devices will also be removed once they are charged, or often before they are fully recharged, sometimes leaving devices that are sub-optimally positioned relative to the wireless charger, and which can then be repositioned as other devices are removed. Accordingly, the wireless charger, remote device, or repeater that is determining the efficiency will also detect the absence of devices that were being charged, such as by a lack of response to a probe or poll message. As devices are removed, then, the system can prompt users to reposition devices still remaining to optimize efficiency.

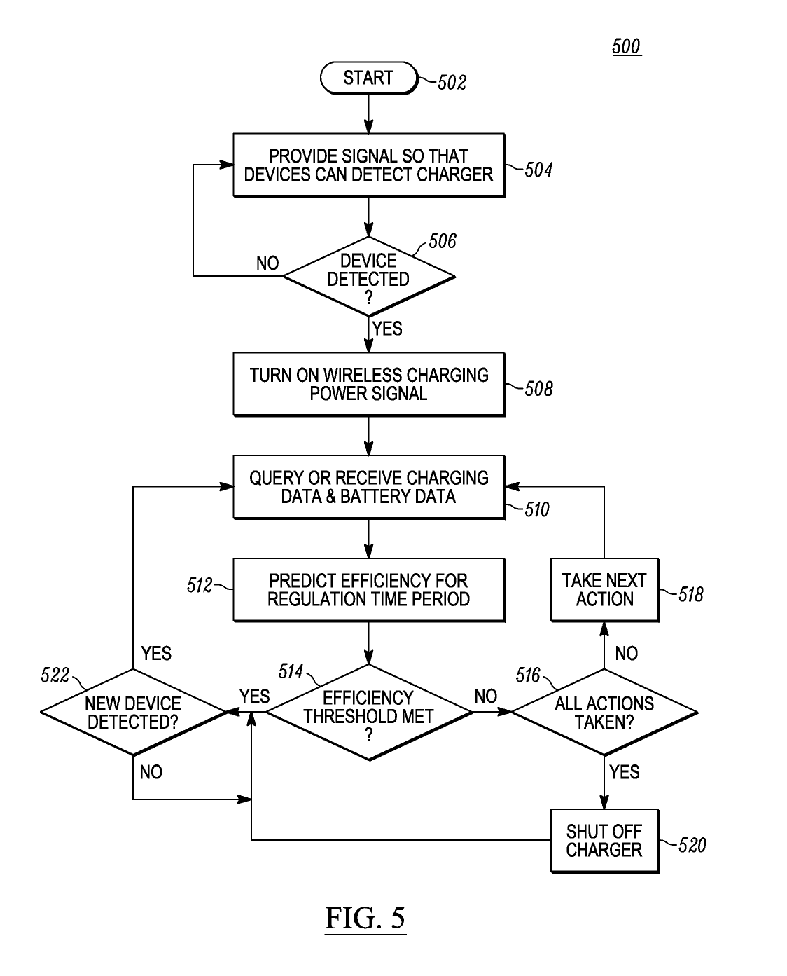

FIG. 5 is a flowchart of a method 500 used by a wireless charger to meet a charging efficiency requirement, in accordance with some embodiments. At the start 502, a wireless charger can be powered up and ready to provide a wireless charging power signal. In order for devices to detect the wireless charger when it is not providing the wireless charging power signal, the wireless charger can periodically provide signal in step 504 to allow devices to detect being in the presence of the wireless charger. Once a device detects the wireless charger, it can attempt communicate with the wireless charger, allowing the wireless charger to detect it in step 506. Once the wireless charger is informed of the presence of the device, in step 508 the wireless charger commences providing the wireless charging power signal. While providing the wireless charging signal, the wireless charger can query each device being charged in step 510, and receive battery and charging data that can be used to determine charging efficiency.

In step 512, the wireless charger (or remote device operating the wireless charger) determines the efficiency. The specific method of determining efficiency can be specified by a regulation or standard which can specify a time period to be used and other criteria to be used. In some cases the efficiency is a predicted efficiency for the system over a prescribed time period based on the amount of useable energy that is being transferred to, and stored in a battery or batteries by the wireless charger. In step 514 the method 500 determines whether the calculated efficiency will meet a preselected threshold (which may be prescribed by regulation or other applicable standard). If the efficiency meets or exceeds the preselected threshold in step 514, then the method commences to step 522 where the wireless charger can determine if there are any new devices to be charged, and if so, obtain the new battery and charging information. However, if in step 514, the desired efficiency is not being met, or is predicted to not be met, then in step 516 the method 500 can determine if all remediation actions have been taken. If not, then the method can proceed to step 518 where the next action in a schedule of actions can be taken to improve charging efficiency. The actions can include, for example, prompting a user to move a particular device for better coupling with the wireless charging power signal, commanding a given device to reduce its power consumption by shutting off unnecessary circuitry, as well as simply shutting off a device. If all remediation actions have been tried with respect to a given device, and the desired efficiency is still not achieved, then the wireless charger can shut off in step 520. If additional devices are added to the system, then the charger can repeat portions of the method as additional devices being charged by the same wireless charging power signal will increase the efficiency, in general. The method 500 is meant to be iterative, and the various processes shown by way of example here can be performed in different orders or in different ways without departing from the inventive aspects of the disclosure. It will be appreciated by those skilled in the art that, although examples may discuss only a single battery, embodiments can address multiple batteries being charged simultaneously in an equivalent manner. Thus, what is done for charging one battery is largely duplicated for charging multiple batteries; the overall system efficiency is based on the sum of the resulting charge capacity and the energy that can be extracted from those batteries relative to the energy used by the system to charge those batteries.

Accordingly, embodiments such as those disclosed herein provide the benefit of, among others, allowing a user to know when, and which devices to reposition in order to improve system efficiency. The efficiency may need to be improved so as to comply with applicable efficiency regulations or other requirements. A predicted efficiency for a present charging condition can be determined based on the energy that can be stored in the battery of each device, resulting from being charged, compared to the energy consumed by the wireless charging system from commercial electrical service to charge those batteries over a given period of time. By informing a user that moving or relocating a device in relation to a wireless power source or wireless charger to modify the efficiency of the system, the system can continue operation in a manner compliant with applicable efficiency regulations.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method for operating a wireless charging system, comprising:
detecting a device containing a battery in charging proximity to a wireless power source, the device containing battery charging metrics;
providing, by the wireless power source, a wireless charging power signal;
communicating the battery charging metrics to the wireless power source;
predicting a charging efficiency for charging the battery according to a charging efficiency standard; and
when the predicted charging efficiency is below a preselected threshold, the wireless charger commencing an action to increase the predicted charging efficiency.

2. The method of claim 1, wherein predicting the charging efficiency comprises:
determining power drawn by the wireless power source from a commercial power source over a period time;
predicting an amount of energy that will be recoverable from the battery based on the battery charging metrics;
determining a ratio of the amount of energy that will be recoverable from the battery to an amount of energy required to charge the battery, based on the power drawn while charging the battery, for a given charging efficiency time period.

3. The method of claim 1, wherein commencing the action to improve the charging efficiency comprises the wireless charger communicating a user-prompt message to move the device relative to the wireless source.

4. The method of claim 1, wherein commencing the action to improve the charging efficiency comprises the wireless power source communicating a message to the device to prompt the device to reduce its power consumption.

5. The method of claim 1, wherein commencing the action to improve the charging efficiency comprises the wireless power source communicating a message to the device to prompt the device to shut off.

6. The method of claim 1, wherein commencing the action to improve the charging efficiency comprises the wireless power source shutting off the wireless charging power signal.

7. The method of claim 1, wherein commencing the action to improve the charging efficiency comprises the wireless power source prompting a user to move the device relative to the wireless power source.

8. The method of claim 1, further comprising:
detecting a plurality of devices and further obtaining battery charging metrics from each of the plurality of devices; and
predicting a system-wide efficiency using the battery charging metrics of all detected devices.

9. The method of claim 1, wherein predicting the charging efficiency for charging the battery according to the charging efficiency standard comprises predicting the charging efficiency for charging the battery according to a government-specified efficiency requirement.

10. The method of claim 1, further comprising selecting the charging efficiency standard as one of a user-selected charging efficiency standard or a manufacturer specified regional charging efficiency standard.

11. A wireless power source, comprising:
a charging coil which is driven to provide a wireless charging power signal in proximity to the charging coil;
a communication circuit that communicates with a device having a rechargeable battery; and
a controller that receives battery charging metric information from the device via the communication circuit, and which determines a predicted charging efficiency according to a charging efficiency standard;
when the predicted charging efficiency is below a preselected threshold, the wireless power source commences an action to increase the predicted charging efficiency.

12. The wireless power source of claim 11, wherein the controller, to predict the charging efficiency, determines a total power drawn by the wireless power source from a commercial power source over a period time; and
The controller further determines an amount of energy that will be recoverable from the battery based on the battery charging metrics and determines a ratio of the amount of energy that will be recoverable from the battery to an amount of energy required to charge the battery, based on the power drawn while charging the battery, for a given charging efficiency time period.

13. The wireless power source of claim 11, wherein the wireless power source communicates a user-prompt message to move the device relative to the wireless power source when the predicted charging efficiency is below the preselected threshold.

14. The wireless power source of claim 11, wherein the wireless power source communicates a message to the device to prompt the device to reduce its power consumption when the predicted charging efficiency is below the preselected threshold.

15. The wireless power source of claim 11, wherein the wireless power source communicates a message to the device to prompt the device to shut off when the predicted charging efficiency is below the preselected threshold.

16. The wireless power source of claim 11, wherein the wireless power source shuts off the wireless charging power signal when the predicted charging efficiency is below the preselected threshold.

17. The wireless power source of claim 11, wherein the wireless power source prompts a user to move the device relative to the wireless power source when the predicted charging efficiency is below the preselected threshold.

18. A wireless battery charging system, comprising:
at least one device having a battery and a receiving coil for wirelessly receiving electrical energy to charge the battery;
a wireless power source having a charging coil which is driven to provide a wireless charging power signal in proximity to the charging coil, a communication circuit that communicates with the at least one device, and a controller that receives battery charging metric information from the at least one device via the communication circuit, and which determines a predicted charging efficiency according to a charging efficiency standard;
when the predicted charging efficiency is below a preselected threshold, the wireless power source commences an action to increase the predicted charging efficiency.

19. The wireless battery charging system of claim 18, wherein the controller of the wireless power source, to predict the charging efficiency, determines a total power drawn by the wireless power source from a commercial power source over a period time; and
The controller further determines an amount of energy that will be recoverable from the battery based on the battery charging metrics and determines a ratio of the amount of energy that will be recoverable from the battery to an amount of energy required to charge the battery, based on the power drawn while charging the battery, for a given charging efficiency time period.

20. The wireless battery charging system of claim 18, wherein, when the predicted charging efficiency is below the preselected threshold, the action commenced by the wireless power source is at least one of:
communicating a user-prompt message to move the device relative to the wireless power source;
communicating a message to the device to prompt the device to reduce its power consumption;
communicating a message to the device to prompt the device to shut off; or
shutting off the wireless charging power signal.
